(19) United States
(12) Patent Application Publication
(10) Pub. No.: US 2017/0061207 A1
(43) Pub. Date: Mar. 2, 2017

(54) APPARATUS AND METHOD FOR DOCUMENT IMAGE ORIENTATION DETECTION

(71) Applicant: FUJITSU LIMITED, Kawasaki-shi (JP)

(72) Inventor: Jun SUN, Beijing (CN)

(73) Assignee: FUJITSU LIMITED, Kawasaki-shi (JP)

(21) Appl. No.: 15/253,999

(22) Filed: Sep. 1, 2016

(30) Foreign Application Priority Data
Sep. 2, 2015 (CN) 201510556826.0

(51) Int. Cl. G06K 9/00; G06T 7/60; G06K 9/62; G06T 7/00

(52) U.S. Cl. CPC G06K 9/00442; G06T 7/004; G06T 7/60; G06K 9/6215; G06T 2207/30176

(57) ABSTRACT

An apparatus and method for document image orientation detection. When a ratio of a difference between similarities between a current text line and reference samples in two selected candidate orientations is greater than or equal to a first threshold value, 1 is added to a voting value of a candidate orientation corresponding to the largest similarity in the orientations, and when the ratio of the difference is less than the first threshold value, a product of the ratio of the difference and a parameter related to the first threshold value is added to the voting value of the candidate orientation corresponding to the largest similarity in the orientations. Hence, setting a voting value can efficiently lower influence of noise text lines, low-quality text lines and unsupported text lines on the orientation detection, thereby achieving accurate document image orientation detection.

### CROSS-REFERENCE TO RELATED APPLICATIONS

This application claims the priority benefit of Chinese Patent Application No. 201510556826.0, filed on Sep. 2, 2015 in the Chinese State Intellectual Property Office, the disclosure of which is incorporated herein in its entirety by reference.

### BACKGROUND

1. Field

The present disclosure relates to the field of image processing, and in particular to an apparatus and method for document image orientation detection.

2. Description of the Related Art

As continuous development of information technologies, applications of filing and recognition of document images are gradually popular. And document image orientation detection is one of premises for achieving the filing and recognition of the document images.

Currently, many methods are used for document image orientation detection. For example, an existing first detection method performs orientation detection based on distribution of shapes and positions of connected components of features, an existing second detection method determines an orientation by focusing only on Latin characters and detecting features of special characters, such as “i” or “T”, and an existing third detection method detects an orientation by voting according to a result of optical character recognition (OCR).

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

Additional aspects and/or advantages will be set forth in part in the description which follows and, in part, will be apparent from the description, or may be learned by practice of the disclosure.

It was found by the inventors of the present disclosure that when the existing first detection method is used, its robustness is relatively poor as Asian scripts include many different shape character sets, and for example, when the noise level is high due to paper or resolution, the connected component based feature becomes unreliable, thereby affecting the detection precision. The same problem exists also in the existing second detection method. And when the existing third detection method is used, when the noise text line removal function is too strong, many candidate true text lines are removed, resulting in that there are few text lines for voting, and the detection result is not reliable. Furthermore, as a vote value is an integer, even when the confidence on one orientation is not high, the vote is still 1 for the highest confident orientation. The influence from image noise and OCR error on the detection result is very big.

Embodiments of the present disclosure provide an apparatus and method for document image orientation detection, in which setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

According to a first aspect of the embodiments of the present disclosure, there is provided an apparatus for document image orientation detection, including: a voting unit configured to vote for text lines in a document image line by line, the voting unit including: a first calculating unit configured to calculate similarities between a current text line and reference samples in multiple candidate orientations; a selecting unit configured to select two candidate orientations from the multiple candidate orientations; where, the similarities between the current text line and reference samples in the two selected candidate orientations are largest and second largest; a second calculating unit configured to calculate a ratio of difference between the similarities between the current text line and reference samples in the two selected candidate orientations; and an adding unit configured to add 1 to a voting value of a candidate orientation corresponding to the largest similarity in the two selected candidate orientations when the ratio of difference is greater than or equal to a first threshold value, and add a product of the ratio of difference and a parameter related to the first threshold value to the voting value of the candidate orientation corresponding to the largest similarity in the two selected candidate orientations when the ratio of difference is less than the first threshold value; and the apparatus further including: a determining unit configured to determine the document image orientation as a candidate orientation having a largest voting accumulative value in the multiple candidate orientations when a difference between the largest voting accumulative value and a second largest voting accumulative value in voting accumulative values of the multiple candidate orientations is greater than or equal to a second threshold value.

According to a second aspect of the embodiments of the present disclosure, there is provided a method for document image orientation detection, including: voting for text lines in a document image line by line, voting for each text line including: calculating similarities between a current text line and reference samples in multiple candidate orientations; selecting two candidate orientations from the multiple candidate orientations; wherein, the similarities between the current text line and reference samples in the two selected candidate orientations are largest and second largest; calculating a ratio of difference between the similarities between the current text line and reference samples in the two selected candidate orientations; and adding 1 to a voting value of a candidate orientation corresponding to the largest similarity in the two selected candidate orientations when the ratio of difference is greater than or equal to a first threshold value, and adding a product of the ratio of difference and a parameter related to the first threshold value to the voting value of the candidate orientation corresponding to the largest similarity in the two selected candidate orientations when the ratio of difference is less than the first threshold value; and the method further including: determining the document image orientation as a candidate orientation having a largest voting accumulative value in the multiple candidate orientations when a difference between the largest voting accumulative value and a second largest voting accumulative value in voting accumulative values of the multiple candidate orientations is greater than or equal to a second threshold value.

An advantage of the embodiments of the present disclosure exists in that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

With reference to the following description and drawings, the particular embodiments of the present disclosure are disclosed in detail, and the principles of the present disclosure and the manners of use are indicated. It should be understood that the scope of embodiments of the present disclosure is not limited thereto. Embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may obtain other accompanying drawings according to these accompanying drawings without making an inventive effort. In the drawings:

FIG. 1 is a schematic diagram of a structure of the apparatus for document image orientation detection of Embodiment 1 of the present disclosure;

FIG. 2 is a schematic diagram of a print text line of Embodiment 1 of the present disclosure;

FIG. 3 is a schematic diagram of a noise text line of Embodiment 1 of the present disclosure;

FIG. 4 is a schematic diagram of a script text line of Embodiment 1 of the present disclosure;

FIG. 5 is a schematic diagram of a structure of the electronic device of Embodiment 2 of the present disclosure;

FIG. 6 is a block diagram of a systematic structure of the electronic device of Embodiment 2 of the present disclosure;

FIG. 7 is a flowchart of the method for document image orientation detection of Embodiment 3 of the present disclosure;

FIG. 8 is a flowchart of the method for voting for each text line in step 701 in FIG. 7; and FIG. 9 is a flowchart of the method for document image orientation detection of Embodiment 4 of the present disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

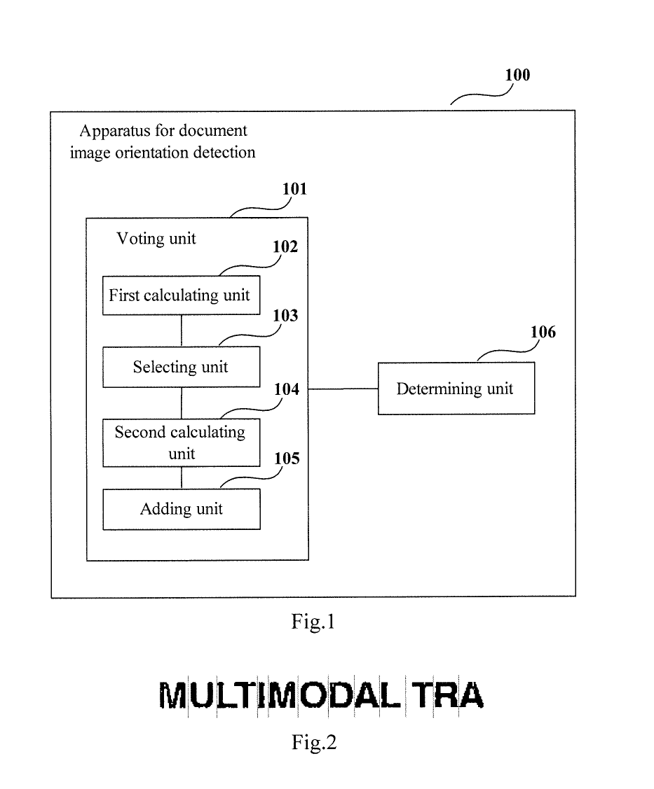

FIG. 1 is a schematic diagram of a structure of the apparatus for document image orientation detection of Embodiment 1 of the present disclosure. As shown in FIG. 1, the apparatus 100 includes:
a voting unit 101 configured to vote for text lines in a document image line by line, the voting unit including:
a first calculating unit 102 configured to calculate similarities between a current text line and reference samples in multiple candidate orientations;
a selecting unit 103 configured to select two candidate orientations from the multiple candidate orientations; wherein, the similarities between the current text line and reference samples in the two selected candidate orientations are largest and second largest;
a second calculating unit 104 configured to calculate a ratio of difference between the similarities between the current text line and reference samples in the two selected candidate orientations; and
an adding unit 105 configured to add 1 to a voting value of a candidate orientation corresponding to the largest similarity in the two selected candidate orientations when the ratio of difference is greater than or equal to a first threshold value, and add a product of the ratio of difference and a parameter related to the first threshold value to the voting value of the candidate orientation corresponding to the largest similarity in the two selected candidate orientations when the ratio of difference is less than the first threshold value.

And the apparatus 100 further includes:
a determining unit 106 configured to determine the document image orientation as a candidate orientation having a largest voting accumulative value in the multiple candidate orientations when a difference between the largest voting accumulative value and a second largest voting accumulative value in voting accumulative values of the multiple candidate orientations is greater than or equal to a second threshold value.

It can be seen from the above embodiment that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

In this embodiment, the document image may be obtained by scanning the document by using an existing scanning method. Furthermore, the document may be placed vertically, and may also be placed horizontally.

In this embodiment, the orientation of the document image corresponds to the orientation of text lines in the document image, which includes 0 degree, 180 degrees, 90 degrees, or 270 degrees. For example, when a document having horizontal text lines is normally placed, the orientation of the text lines is horizontal, that is, the orientation of the text lines is 0 degree or 180 degrees, the orientation of the document image is also 0 degree or 180 degrees; and when the document is placed by turning by 90 degrees or 270 degrees, the orientation of the text lines is vertical, that is, the orientation of the text lines is 90 degrees or 270 degrees, the orientation of the document image is also 90 degrees or 270 degrees.

In this embodiment, the voting unit 101 votes for the text lines in the document image line by line. For example, the voting may be performed line by line in an arrangement order of the text lines in the document image, and may also be performed line by line by selecting part of the text lines.

In this embodiment, the multiple candidate orientations may be set according to an actual situation, and may include at least two candidate orientations. For example, for a normally typesetting document image, the multiple candidate orientations may include four candidate orientations, 0-degree orientation, 90-degree orientation, 180-degree orientation, and 270-degree orientation. In this embodiment, the description shall be exemplarily given taken these four orientations as examples.

In this embodiment, the first calculating unit 102 calculates the similarities between the current text line and the reference samples in the multiple candidate orientations.

In this embodiment, the reference samples are pre-obtained reference samples. For example, the reference samples are standard samples or pre-collected training samples.

In this embodiment, the reference samples in the multiple candidate orientations refer to reference samples obtained by turning the reference samples by angles corresponding to the candidate orientations. For example, when the multiple candidate orientations are 0-degree orientation, 90-degree orientation, 180-degree orientation and 270-degree orientation, the reference sample in the 0-degree orientation is an original reference sample, the reference sample in the 90-degree orientation is a reference sample obtained by turning the original reference sample by 90 degrees, the reference sample in the 180-degree orientation is a reference sample obtained by turning the original reference sample by 180 degrees, and the reference sample in the 270-degree orientation is a reference sample obtained by turning the original reference sample by 270 degrees.

In this embodiment, an existing method may be used to calculate the similarities between the current text line and the reference samples in the multiple candidate orientations. For example, the similarities may be measured by using average recognition distances or confidence between the current text line and the reference samples, and may also be measured by using the numbers of assured characters in the orientations. And a measurement method for the similarities is not limited in embodiments of the present disclosure.

In this embodiment, many methods may be used to calculate the average recognition distances or confidence between the current text line and the reference samples. For example, the average recognition distances or confidence between the current text line and the reference samples may be calculated based on a result of optical character recognition (OCR), the average recognition distances or confidence between the current text line and the reference samples may be calculated based on rise and drop of strokes, orientations of the strokes, or vertical component run (VCR) of the strokes, or the average recognition distances or confidence between the current text line and the reference samples may be calculated based on texture features of the text line. For example, the smaller the average recognition distance between the current text line and a reference sample, the higher the similarity, and the higher the confidence between the current text line and a reference sample, the higher the similarity.

In this embodiment, after the similarities between the current text line and the reference samples in the multiple candidate orientations are calculated, the selecting unit 103 selects two candidate orientations, so that the similarities between the current text line and reference samples in the two selected candidate orientations are largest and second largest.

In this embodiment, the second calculating unit 104 is configured to calculate the ratio of the difference between the similarities between the current text line and the reference samples in the two selected candidate orientations. For example, the numerator of the ratio of the difference is a difference between the similarities between the current text line and the reference samples in the two selected candidate orientations, and the denominator of the ratio of the difference may be the largest similarity, the second largest similarity, or an average value of the largest similarity and the second largest similarity.

In this embodiment, the ratio of the difference may be a ratio of the difference between the similarities between the current text line and the reference samples in the two selected candidate orientations to the largest similarity. Hence, influences of noise text lines or low-quality text lines on the result of detection may further be lowered.

In this embodiment, the adding unit 105 is configured to add 1 to a voting value of a candidate orientation corresponding to the largest similarity in the two selected candidate orientations when the ratio of difference is greater than or equal to a first threshold value, and add a product of the ratio of difference and a parameter related to the first threshold value to the voting value of the candidate orientation corresponding to the largest similarity in the two selected candidate orientations when the ratio of difference is less than the first threshold value.

Hence, by performing differentiated voting by judging whether the ratio of difference is greater than or equal to the first threshold value, and when the voting value is a relatively small value when the ratio of difference is less than the first threshold value, right text lines are ensured not to be removed and reasonable voting may be obtained, and influences of noise text lines, low-quality text lines and unsupported text lines on the detection of the orientations may be efficiently lowered.

In this embodiment, a first judging unit (not shown in FIG. 1) may be included, which is configured to judge whether the ratio of difference is greater than or equal to the first threshold value. The first judging unit may be provided in the voting unit 101, and may also be provided in the apparatus 100 for detection. A position of the first judging unit is not limited in embodiments of the present disclosure.

In this embodiment, the first threshold value may be set according to an actual situation. For example, the first threshold value is denoted by T1, T being a numeral value less than 0.5, for example, T=0.1.

In this embodiment, a parameter range related to the first threshold value may be set according to an actual situation. For example, the parameter is denoted by C, 0<C<1 /T, T being the first threshold value.

In this embodiment, the ratio of the difference between the similarities between the current text line and the reference samples in the two selected candidate orientations is denoted by R, and as a product of the ratio R of the difference and the parameter C related to the first threshold value is calculated only when the ratio R of the difference is less than T and C<1/T, R×C is a numeral value less than 1. For example, C=1/(2T), and at this moment, R×C is a numeral value less than 0.5.

In this embodiment, the voting unit 101 votes for the text lines in the document image line by line. For example, the adding unit 105 adds 1 to the voting value V of the candidate orientation corresponding to the largest similarity in the two selected candidate orientations when the voting unit 101 votes for the current text and the ratio R of the difference is greater than or equal to T, and add R×C to the voting value V when the ratio R of the difference is less than T.

In this embodiment, the determining unit 106 is configured to determine the document image orientation as a candidate orientation having a largest voting accumulative value in the multiple candidate orientations when the difference between the largest voting accumulative value and the second largest voting accumulative value in the voting accumulative values of the multiple candidate orientations is greater than or equal to the second threshold value.

In this embodiment, the second threshold value may be set according to an actual situation. For example, the second threshold value is an integer greater than or equal to 2, for example, the second threshold value is 2.

In this embodiment, a second judging unit (not shown in FIG. 1) may be included, which is configured to judge whether the difference between the largest voting accumulative value and the second largest voting accumulative value in the voting accumulative values in the multiple candidate orientations is greater than or equal to the second threshold value. The second judging unit may be provided in the determining unit 106, and may also be provided in the apparatus 100 for detection. A position of the second judging unit is not limited in embodiments of the present disclosure.

The method for voting of this embodiment shall be exemplarily described taking that the average recognition distances between the text line and the reference sample is the metric of the similarity as an example.

In this embodiment, the first threshold value is set to be 0.1, the second threshold value is set to be 2, and C is set to be 1/(2T), that is, C=5.

FIG. 2 is a schematic diagram of a print text line of Embodiment 1 of the present disclosure. The print text line has a largest similarity and a second largest similarity with the reference samples in the 0-degree orientation and the 180-degree orientation. Table 1 gives average recognition distances between the print text line shown in FIG. 2 and the reference samples in the 0-degree orientation and the 180-degree orientation.

TABLE 1

| Serial | Recognition distance in | Recognition distance in |
|---|---|---|
| number | the 0-degree orientation | the 180-degree orientation |
| 0 | 835 | 1040 |
| 1 | 545 | 514 |
| 2 | 1120 | 1038 |
| 3 | 779 | 784 |
| 4 | 816 | 1036 |
| 5 | 573 | 512 |
| 6 | 857 | 908 |
| 7 | 865 | 760 |
| 8 | 486 | 1079 |
| 9 | 1074 | 1255 |
| 10 | 518 | 1128 |
| 11 | 1036 | 791 |
| Average | 792 | 906 |
| recognition | | |
| distance | | |

It can be seen from Table 1 that the average recognition distance between the print text line and the reference sample in the 0-degree orientation is minimum, and the average recognition distance between the print text line and the reference sample in the 180-degree orientation is second minimum, that is, the similarity between the print text line and the reference sample in the 0-degree orientation is largest, and the similarity between the print text line and the reference sample in the 180-degree orientation is second largest.

Hence, the ratio R of the difference between similarities between the print text line and the reference samples in the 0-degree orientation and the 180-degree orientation is (906−792)/792≈0.144. Thus, R>T at this moment, and 1 is added to the voting value V of the 0-degree orientation.

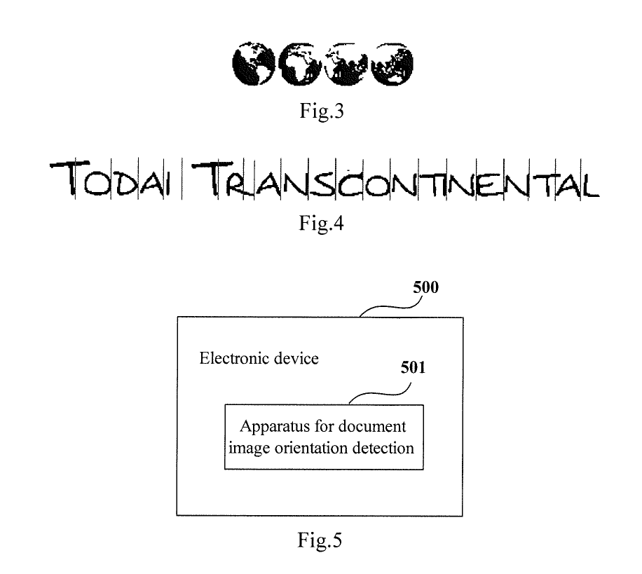

FIG. 3 is a schematic diagram of a noise text line of Embodiment 1 of the present disclosure. As shown in FIG. 3, the text line is not an actual text line, but a text line formed by arranging multiple graphs. The noise text line has a largest similarity and a second largest similarity with the reference samples in the 0-degree orientation and the 180-degree orientation. Table 2 gives average recognition distances between the noise text line shown in FIG. 3 and the reference samples in the 0-degree orientation and the 180-degree orientation.

TABLE 2

| Serial | Recognition distance in | Recognition distance in |
|---|---|---|
| number | the 0-degree orientation | the 180-degree orientation |
| 0 | 1585 | 1679 |
| 1 | 1510 | 1506 |
| 2 | 1636 | 1568 |
| 3 | 1671 | 1600 |
| Average | 1600 | 1588 |
| recognition | | |
| distance | | |

It can be seen from Table 2 that the average recognition distance between the noise text line and the reference sample in the 180-degree orientation is minimum, and the average recognition distance between the noise text line and the reference sample in the 0-degree orientation is second minimum, that is, the similarity between the noise text line and the reference sample in the 180-degree orientation is largest, and the similarity between the noise text line and the reference sample in the 0-degree orientation is second largest.

Hence, the ratio R of the difference between similarities between the noise text line and the reference samples in the 180-degree orientation and the 0-degree orientation is (1600−1588)/1588≈0.008. Thus, R<T at this moment, R×C=0.008×5=0.04, and 0.04 is added to the voting value of the 180-degree orientation.

It can be seen that the voting value produced by the noise text line shown in FIG. 3 is very small, which may efficiently lower the influence of the noise text line on the detection of the orientation.

FIG. 4 is a schematic diagram of a script text line of Embodiment 1 of the present disclosure. The script text line has a largest similarity and a second largest similarity with the reference samples in the 0-degree orientation and the 180-degree orientation. Table 3 gives average recognition distances between the script text line shown in FIG. 4 and the reference samples in the 0-degree orientation and the 180-degree orientation.

TABLE 3

| Serial | Recognition distance in | Recognition distance in |
|---|---|---|
| number | the 0-degree orientation | the 180-degree orientation |
| 0 | 1060 | 631 |
| 1 | 1137 | 1374 |
| 2 | 1224 | 1061 |
| 3 | 1267 | 1305 |
| 4 | 509 | 1412 |
| 5 | 1159 | 568 |
| 6 | 1667 | 599 |
| 7 | 915 | 1490 |
| 8 | 1191 | 1067 |
| 9 | 1364 | 1431 |
| 10 | 1227 | 1398 |
| 11 | 1255 | 1461 |
| 12 | 823 | 1068 |
| 13 | 1400 | 869 |
| 14 | 1478 | 1519 |
| 15 | 1450 | 919 |
| 16 | 1141 | 1538 |
| 17 | 1380 | 947 |
| 18 | 1033 | 1441 |
| 19 | 1221 | 1130 |
| 20 | 526 | 1600 |
| Average | 1254 | 1283 |
| recognition | | |
| distance | | |

It can be seen from Table 3 that the average recognition distance between the script text line and the reference sample in the 0-degree orientation is minimum, and the average recognition distance between the script text line and the reference sample in the 180-degree orientation is second minimum, that is, the similarity between the script text line and the reference sample in the 0-degree orientation is largest, and the similarity between the script text line and the reference sample in the 180-degree orientation is second largest.

Hence, the ratio R of the difference between similarities between the script text line and the reference samples in the 0-degree orientation and the 180-degree orientation is (1283−1254)/1254≈0.023. Thus, R<T at this moment, R×C=0.023×5≈0.12, and 0.12 is added to the voting value of the 0-degree orientation.

In this embodiment, it is assumed that a first line to a third line of the text lines of the document image are the text lines shown in FIGS. 2-4, a fourth line to a sixth line are repeated text lines shown in FIGS. 2-4, the candidate orientations are 0-degree orientation, 90-degree orientation, 180-degree orientation and 270-degree orientation, and all initial voting values of the candidate orientations are 0.

Then, when voting is performed on the first line, 1 is added to the voting value of the 0-degree orientation, when voting is performed on the second line, 0.04 is added to the voting value of the 180-degree orientation, and when voting is performed on the third line, 0.12 is added to the voting value of the 0-degree orientation, and at this moment, a voting accumulative value of the 0-degree orientation is 1.12, and a voting accumulative value of the 180-degree orientation is 0.04; then voting is performed on the fourth line, 1 is added to the voting value of the 0-degree orientation, and at this moment, a voting accumulative value of the 0-degree orientation is 2.12, a difference between which and a voting accumulative value of the 180-degree orientation being 2.08, which exceeds the second threshold value 2, and at this moment, the voting is terminated, and the orientation of the document image is determined as the 0-degree orientation.

It can be seen from the above embodiment that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

### Embodiment 2

An embodiment of the present disclosure further provides an electronic device. FIG. 5 is a schematic diagram of a structure of the electronic device of Embodiment 2 of the present disclosure. As shown in FIG. 5, the electronic device 500 includes an apparatus 501 for document image orientation detection. In this embodiment, a structure and functions of the apparatus 501 for document image orientation detection are identical to those as described in Embodiment 1, and shall not be described herein any further. In this embodiment, the electronic device is, for example, a scanner.

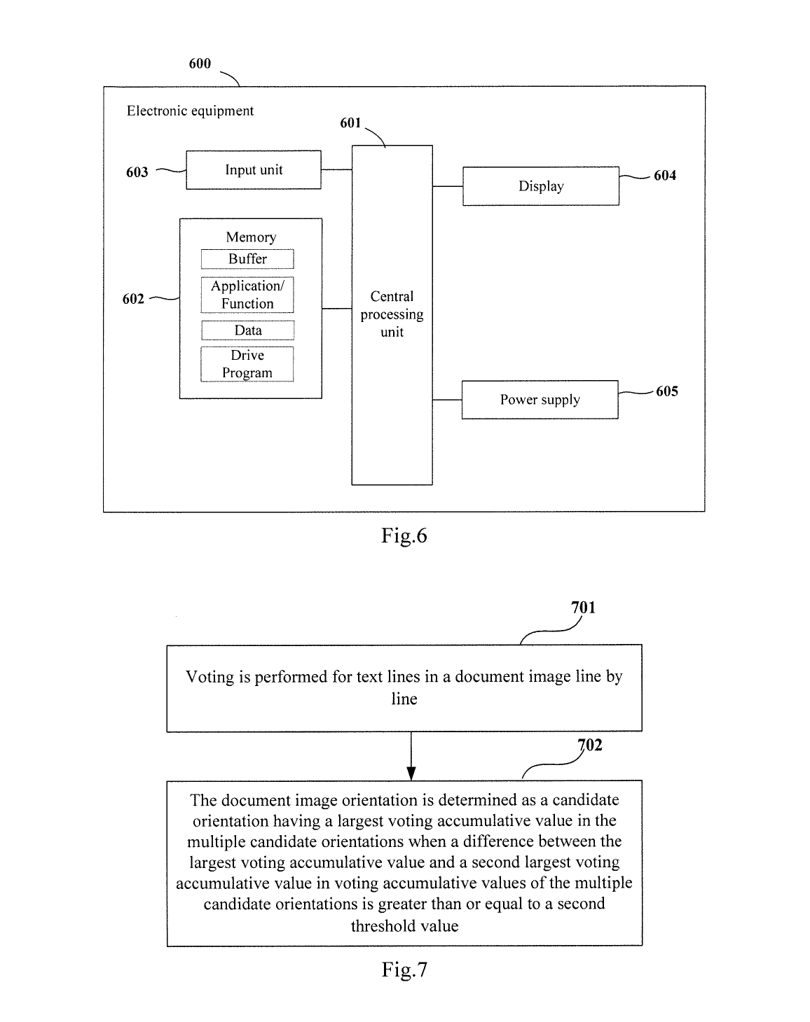

FIG. 6 is a block diagram of a systematic structure of the electronic device of Embodiment 2 of the present disclosure. As shown in FIG. 6, the electronic device 600 may include a central processing unit 601 and a memory 602, the memory 602 being coupled to the central processing unit 601. This figure is illustrative only, and other types of structures may also be used, so as to supplement or replace this structure and achieve telecommunications function or other functions.

As shown in FIG. 6, the electronic device 600 may further include an input unit 603, a display 604 and a power supply 605.

In an implementation, the function of the apparatus for document image orientation detection described in Embodiment 1 may be integrated into the central processing unit 601. For example, the central processing unit 601 may be configured to: vote for text lines in a document image line by line, the voting for each text line including: calculating similarities between a current text line and reference samples in multiple candidate orientations; select two candidate orientations from the multiple candidate orientations, the similarities between the current text line and reference samples in the two selected candidate orientations are largest and second largest; calculate a ratio of difference between the similarities between the current text line and reference samples in the two selected candidate orientations; and add 1 to a voting value of a candidate orientation corresponding to the largest similarity in the two selected candidate orientations when the ratio of difference is greater than or equal to a first threshold value, and add a product of the ratio of difference and a parameter related to the first threshold value to the voting value of the candidate orientation corresponding to the largest similarity in the two selected candidate orientations when the ratio of difference is less than the first threshold value; and the central processing unit 601 may further be configured to: determine the document image orientation as a candidate orientation having a largest voting accumulative value in the multiple candidate orientations when a difference between the largest voting accumulative value and a second largest voting accumulative value in voting accumulative values of the multiple candidate orientations is greater than or equal to a second threshold value.

For example, the ratio of difference between the similarities between the current text line and the reference samples in the two selected candidate orientations is a ratio of a difference between the similarities between the current text line and the reference samples in the two selected candidate orientations to the largest similarity.

For example, the parameter C related to the first threshold value satisfies 0<C<1/T; where, T is the first threshold value.

For example, C=1/(2T); where, T is the first threshold value.

For example, the similarities between the current text line and the reference samples in the multiple candidate orientations are calculated according to any one of the following methods: being based on optical character recognition (OCR); being based on rise and fall of strokes, being based on orientations of strokes or being based on a vertical component run (VCR) of strokes; and being based on texture features of the text line.

In another implementation, the apparatus for document image orientation detection described in Embodiment 1 and the central processing unit 601 may be configured separately. For example, the apparatus for document image orientation detection may be configured as a chip connected to the central processing unit 601, with its functions being realized under control of the central processing unit 601.

In this embodiment, the electronic device 600 does not necessarily include all the parts shown in FIG. 6.

As shown in FIG. 6, the central processing unit 601 is sometimes referred to as a controller or control, and may include a microprocessor or other processor devices and/or logic devices. The central processing unit 601 receives input and controls operations of every components of the electronic device 600.

The memory 602 may be, for example, one or more of a buffer memory, a flash memory, a hard drive, a mobile medium, a volatile memory, a nonvolatile memory, or other suitable devices. And the central processing unit 601 may execute the program stored in the memory 602, so as to realize information storage or processing, etc. Functions of other parts are similar to those of the related art, which shall not be described herein any further. The parts of the electronic device 600 may be realized by specific hardware, firmware, software, or any combination thereof, without departing from the scope of the present disclosure.

It can be seen from the above embodiment that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

### Embodiment 3

An embodiment of the present disclosure further provides a method for document image orientation detection, corresponding to the apparatus for document image orientation detection described in Embodiment 1. FIG. 7 is a flowchart of the method for document image orientation detection of Embodiment 3 of the present disclosure. As shown in FIG. 7, the method includes:
Step 701: voting is performed for text lines in a document image line by line; and
Step 702: the document image orientation is determined as a candidate orientation having a largest voting accumulative value in the multiple candidate orientations when a difference between the largest voting accumulative value and a second largest voting accumulative value in voting accumulative values of the multiple candidate orientations is greater than or equal to a second threshold value.

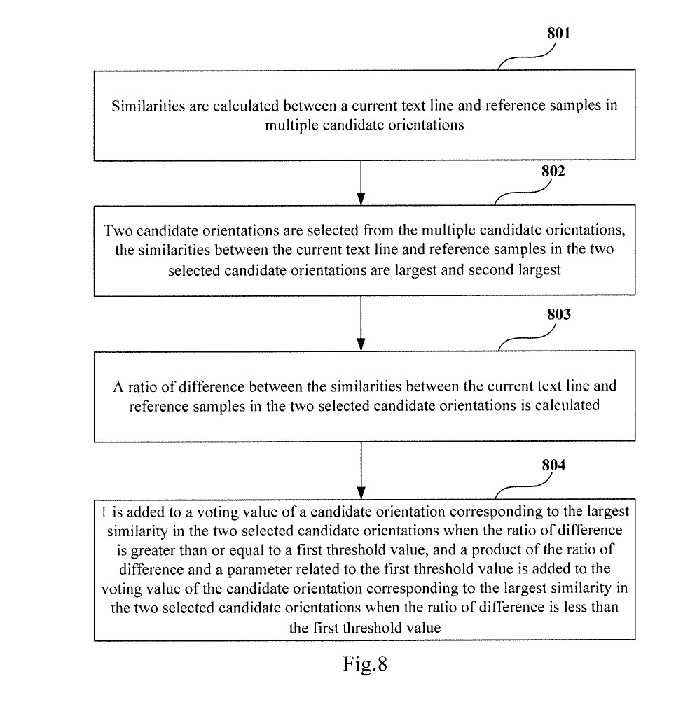

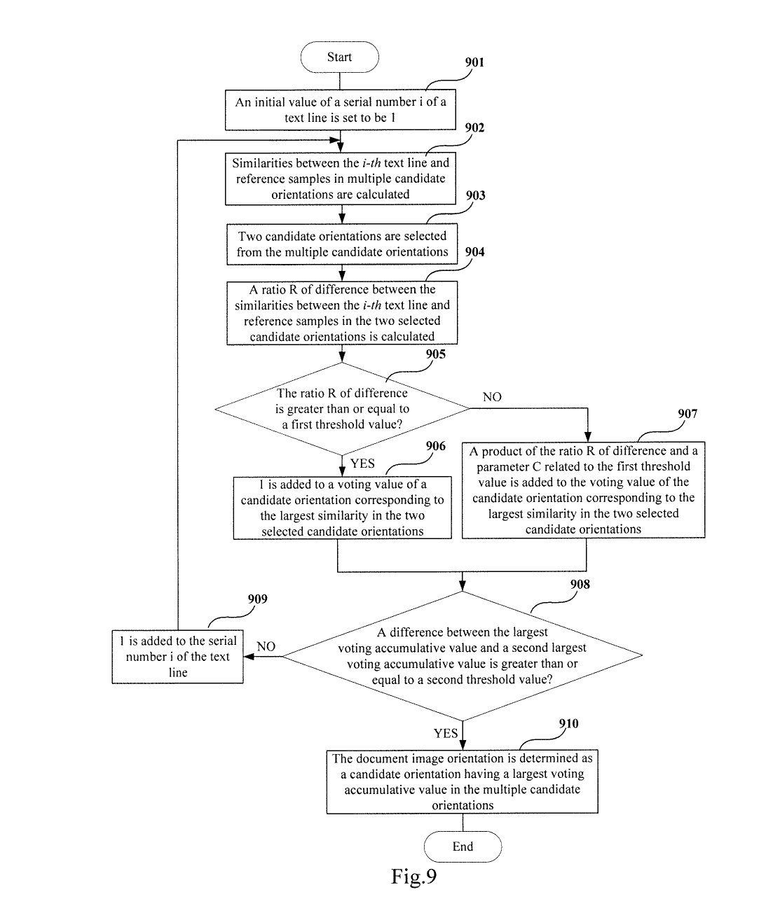

FIG. 8 is a flowchart of the method for voting for each text line in step 701 in FIG. 7. As shown in FIG. 8, the method includes:
Step 801: similarities are calculated between a current text line and reference samples in multiple candidate orientations;
Step 802: two candidate orientations are selected from the multiple candidate orientations, the similarities between the current text line and reference samples in the two selected candidate orientations are largest and second largest;
Step 803: a ratio of difference between the similarities between the current text line and reference samples in the two selected candidate orientations is calculated; and

Step 804: 1 is added to a voting value of a candidate orientation corresponding to the largest similarity in the two selected candidate orientations when the ratio of difference is greater than or equal to a first threshold value, and a product of the ratio of difference and a parameter related to the first threshold value is added to the voting value of the candidate orientation corresponding to the largest similarity in the two selected candidate orientations when the ratio of difference is less than the first threshold value.

In this embodiment, the method for voting for each text line is identical to that described in Embodiment 1, and shall not be described herein any further.

It can be seen from the above embodiment that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

### Embodiment 4

An embodiment of the present disclosure further provides a method for document image orientation detection, corresponding to the apparatus for document image orientation detection described in Embodiment 1. FIG. 9 is a flowchart of the method for document image orientation detection of Embodiment 4 of the present disclosure. As shown in FIG. 9, the method includes:
Sep 901: an initial value of a serial number i of a text line is set to be 1, i being a positive integer;
Step 902: similarities between the i-th text line and reference samples in multiple candidate orientations are calculated;
Step 903: two candidate orientations are selected from the multiple candidate orientations, the similarities between the i-th text line and reference samples in the two selected candidate orientations are largest and second largest;
Step 904: a ratio R of difference between the similarities between the i-th text line and reference samples in the two selected candidate orientations is calculated;
Step 905: it is judged whether the ratio R of difference is greater than or equal to a first threshold value, entering into step 906 when a result of judgment is yes, and entering into step 907 when the result of judgment is no;
Step 906: 1 is added to a voting value of a candidate orientation corresponding to the largest similarity in the two selected candidate orientations;
Step 907: a product of the ratio R of difference and a parameter C related to the first threshold value is added to the voting value of the candidate orientation corresponding to the largest similarity in the two selected candidate orientations;
Step 908: it is judged whether a difference between the largest voting accumulative value and a second largest voting accumulative value in voting accumulative values of the multiple candidate orientations is greater than or equal to a second threshold value, entering into step 909 when a result of judgment is no, and entering into step 910 when the result of judgment is yes;
Step 909: 1 is added to the serial number i of the text line; and
Step 910: the document image orientation is determined as a candidate orientation having a largest voting accumulative value in the multiple candidate orientations.

In this embodiment, the method for voting for each text line is identical to that described in Embodiment 1, and shall not be described herein any further.

It can be seen from the above embodiment that setting a voting value for voting for a candidate orientation according to a ratio of difference between similarities between a text line and reference samples in candidate orientations can efficiently lower influences of noise text lines, low-quality text lines and unsupported text lines on the orientation detection, thereby achieving accurate document image orientation detection.

An embodiment of the present disclosure further provides a computer-readable program, when the program is executed in an apparatus for document image orientation detection or an electronic device, the program enables the apparatus for document image orientation detection or electronic device to carry out the method for document image orientation detection as described in Embodiment 3 or 4.

An embodiment of the present disclosure provides a non-transitory storage medium in which a computer-readable program is stored, the computer-readable program enables an apparatus for document image orientation detection or an electronic device to carry out the method for document image orientation detection as described in Embodiment 3 or 4.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a non-transitory storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principles of the present disclosure, and such variants and modifications fall within the scope of the present disclosure.

What is claimed is:

1. An apparatus for document image orientation detection, comprising:
a voting unit configured to vote for text lines in a document image line by line, the voting unit comprising:
a first calculating unit configured to calculate similarities between a current text line and reference samples in multiple candidate orientations;
a selecting unit configured to select two candidate orientations from the multiple candidate orientations where the similarities between the current text line and the reference samples in the two selected candidate orientations are largest and second largest;
a second calculating unit configured to calculate a first ratio of a difference between the similarities between the current text line and the reference samples in the two selected candidate orientations; and
an adding unit configured to add 1 to a voting value of a candidate orientation corresponding to the largest similarity in the two selected candidate orientations when the first ratio of the difference is greater than or equal to a first threshold value, and add a product of the first ratio of the difference and a parameter related to the first threshold value to the voting value of the candidate orientation corresponding to the largest similarity in the two selected candidate orientations when the first ratio of the difference is less than the first threshold value;
and the apparatus further comprising:
a determining unit configured to determine a document image orientation as a candidate orientation having a largest voting cumulative value in the multiple candidate orientations when a value difference between the largest voting cumulative value and a second largest voting accumulative value in voting accumulative values of the multiple candidate orientations is greater than or equal to a second threshold value.

2. The apparatus according to claim 1, wherein the first ratio of the difference between the similarities between the current text line and the reference samples in the two selected candidate orientations is a second ratio of the difference between the similarities between the current text line and the reference samples in the two selected candidate orientations to the largest similarity.

3. The apparatus according to claim 1, wherein a parameter C related to the first threshold value satisfies 0<C<1/T where T is the first threshold value.

4. The apparatus according to claim 3, wherein C=1/(2T) where T is the first threshold value.

5. The apparatus according to claim 1, wherein the first calculating unit calculates the similarities between the current text line and the reference samples in the multiple candidate orientations according to any one of the following methods:
being based on optical character recognition (OCR);
being based on rise and fall of strokes or being based on orientations of strokes or being based on a vertical component run (VCR) of strokes; and
being based on texture features of the text line.

6. A method for document image orientation detection, comprising:
voting for text lines in a document image line by line where voting for each text line comprising:
calculating similarities between a current text line and reference samples in multiple candidate orientations;
selecting two candidate orientations from the multiple candidate orientations where the similarities between the current text line and reference samples in the two selected candidate orientations are largest and second largest;
calculating a first ratio of a first difference between the similarities between the current text line and reference samples in the two selected candidate orientations; and
adding 1 to a voting value of a candidate orientation corresponding to the largest similarity in the two selected candidate orientations when the first ratio of the first difference is greater than or equal to a first threshold value, and adding a product of the first ratio of the first difference and a parameter related to the first threshold value to the voting value of the candidate orientation corresponding to the largest similarity in the two selected candidate orientations when the first ratio of the first difference is less than the first threshold value;
and the method further comprising:
determining the document image orientation as a candidate orientation having a largest voting accumulative value in the multiple candidate orientations when a second difference between the largest voting accumulative value and a second largest voting accumulative value in voting accumulative values of the multiple candidate orientations is greater than or equal to a second threshold value.

7. The method according to claim 6, wherein the first ratio of the first difference between the similarities between the current text line and the reference samples in the two selected candidate orientations is a second ratio of a second difference between the similarities between the current text line and the reference samples in the two selected candidate orientations to the largest similarity.

8. The method according to claim 6, wherein a parameter C related to the first threshold value satisfies 0<C<1 /T where T is the first threshold value.

9. The method according to claim 8, wherein C=1/(2T) where T is the first threshold value.

10. The method according to claim 6, wherein the similarities between the current text line and the reference samples in the multiple candidate orientations are calculated according to any one of the following methods:
being based on optical character recognition (OCR);
being based on rise and fall of strokes or being based on orientations of strokes or being based on a vertical component run (VCR) of strokes; and
being based on texture features of the text line.

11. A non-transitory computer readable storage medium storing a method according to claim 6.
